(19) United States
(12) Patent Application Publication
(10) Pub. No.: US 2008/0154650 A1
(43) Pub. Date: Jun. 26, 2008

(54) Method of managing the business of a health insurance plan and a system therefor

(76) Inventors: Shaun Matisonn, Illovo (ZA); Tal Gilbert, London (GB)

Correspondence Address: MARSHALL & MELHORN, LLC, FOUR SEAGATE - EIGHTH FLOOR, TOLEDO, OH, 43604, US

(21) Appl. No.: 11/903,607

(22) Filed: Sep. 24, 2007

Related U.S. Application Data
(60) Provisional application No. 60/846,490, filed on Sep. 22, 2006.

(51) Int. Cl. G06Q 40/00

(52) U.S. Cl. 705/4

(57) ABSTRACT

A method of managing the business of a health insurance plan is provided. In these types of health insurance plans, the provider of such a health insurance plan undertakes liability in return for a premium or contribution, and insures members who pay such premiums or make such contributions for covered health services or manages an account from which covered health care expenses are paid. The method includes setting up a fund for a member which the member can use to pay for predetermined health related expenses and only allowing the member to access the fund if the member participates in a review of their health.

### CROSS-REFERENCE TO RELATED APPLICATION

This application claims the benefit of U.S. Provisional Application No. 60/846,490, filed Sep. 22, 2006. U.S. Provisional Application No. 60/846,490 is hereby incorporated by reference as if set forth in its entirety herein.

### BACKGROUND OF THE INVENTION

The present invention relates to a method of managing the business of a health insurance plan and a system therefor.

A traditional health insurance plan operates with the insurer of the health plan undertaking liability in return for a premium or contribution and insures members who pay such premiums or make such contributions (or for whom such premium or contribution is paid by the member's employer) for covered health services or manages an account (contributed to by the member or the member's employer) from which covered health care expenses are paid.

The aim of these types of health insurance plans is to afford members access to the best health services which they may otherwise not be able to afford.

From the member's point of view, any incentive that helps the member manage her/his medical expenses more carefully and allows him/her to more easily afford these expenses is beneficial particularly in a rapidly developing consumer driven healthcare environment.

The present invention seeks to address this.

### SUMMARY

According to one example embodiment there is provided a method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
setting up a fund for a member which the member can use to pay for predetermined health related expenses; and
only allowing the member to access the fund if the member participates in a review of their health.

The predetermined health related expenses may be expenses which are not otherwise covered by the health insurance plan.

An example of such health related expenses may be:
eligible benefits without GP referral;
consultations for chronic conditions;
maternity costs;
health screens.

The fund may be accessible by a member for a predetermined period.

Any balance in the fund after the predetermined period may be rolled over to the next predetermined period. This may only apply if the member participated in the review of their health in this predetermined period.

The amount of the fund may be related to at what point in the predetermined period the member participated in the review of their health.

According to another example embodiment there is further provided an electronic system for managing the business of a health insurance plan includes:
a fund module to setting up a fund for a member which the member can use to pay for predetermined health related expenses; and
an access module to only allow the member to access the fund if the member participates in a review of their health.

The access module may only allow the member to access the fund for a predetermined period.

Any balance in the fund after the predetermined period may then be rolled over by the access module to the next predetermined period.

The access module may only make the balance in the fund available if the member participates in the review of their health in this predetermined period.

In addition, the access module may relate the amount of the fund to at what point in the predetermined period the member participated in the review of their health.

### BRIEF DESCRIPTION OF THE DRAWINGS

FIG. 1 is a flow chart illustrating the methodology of an example embodiment; and

FIG. 2 is a block diagram illustrating an example system to implement the methodologies described herein.

### DESCRIPTION OF EMBODIMENTS

The invention finds application in the field of managing the business and operation of a health insurance plan. Typically, the insurer of such health insurance plans undertakes liability in return for a premium or contribution, and insures members who pay such premiums or make such contributions (or for whom such premium or contribution is paid by the member's employer) for covered health services or manages a personal medical fund or any other similar fund governed by respective healthcare and tax legislation (contributed to by the member or the member's employer) from which covered health care expenses are paid.

In certain countries, such health plans are referred to as medical schemes or medical aid schemes.

There are various models of health plans. For example, in one model the health insurer pays for all of the member's health services in particular agreed categories up to a predetermined limit. This predetermined limit is the limit of the health insurer's liability.

In an alternative model, a member has a personal medical fund or medical savings account or any other similar fund governed by respective healthcare and tax legislation which is managed by the health insurer or third party administrator of the health plan, but which the member and/or the member's employer funds. Any health related claims made to the health insurer are then paid by the health insurer or third party administrator from this personal medical fund up to a predetermined amount. Only after the predetermined amount does the health insurer incur liability and pay for the covered health related costs up to another predetermined amount.

In this method, the member typically pays to the health insurer an amount comprised of a risk premium portion in return for which the insurer undertakes liability for covered health services and a fund portion which is credited to the balance of the member's personal medical fund or any other similar fund governed by respective healthcare and tax legislation. It is this fund portion which the insurer or third party administrator will first use to pay for certain itemised covered health related costs incurred by the member.

The present methodology finds application in both of these models, for example, as well as in other models of health plans which are used.

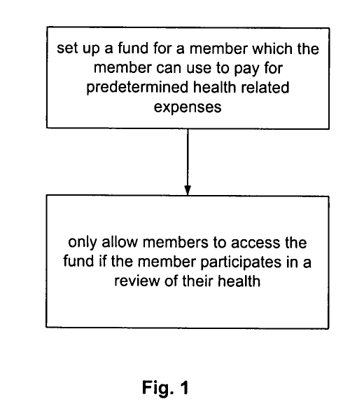

Referring to FIG. 1, in an example embodiment, a fund is set up for a member which the member can use to pay for predetermined health related expenses.

However, the member is only allowed to access the fund if the member participates in a review of their health referred to herein after as a Personal Health Review (PHR). Thus the fund will be allocated as a reward for members completing the Personal Health Review (PHR). This reward will be available on an annual basis as will be described below.

The Personal Health Review is a short questionnaire which will allow members to earn points for finding out a bit more about their own state of health and what they can do to improve it.

The Personal Health Review (PHR) was developed specifically for use online. Although this will be the main source it will be available telephonically and on paper to ensure that nobody is negatively impacted by not having access to it online.

If a member does the PHR online or telephonically, feedback can be given immediately. However with a paper PHR the member will only be sent feedback after the results have been consolidated.

The review is aimed at only adult PMI members, from any type of scheme (individual, SME or corporate).

The PHR is split into sections, at the end of each section the member will receive feedback, which they can print off.

In one example embodiment, the sections are as follows:
Health status
Physical activity
Nutrition
Smoking
Alcohol
Stress

The predetermined health related expenses may be expenses which are not otherwise covered by the health insurance plan.

Some examples of such health related expenses are:
eligible benefits without GP referral;
consultations for chronic conditions;
maternity costs;
health screens.

The fund may be accessible by a member for a predetermined period, for example a year, and any balance in the fund after the predetermined period may be rolled over to the next predetermined period.

This will typically only apply if the member participates in the review of their health in the previous predetermined period although the member will not be required to complete the review again and the funds will be available immediately in the new predetermined period.

The amount of the fund may be related to at what point in the predetermined period the member participated in the review of their health.

Alternatively, the amount of the fund may be allocated to the member irrespective of when the member does the review. Thus, if the member does the PHR part way through the year the fund amount will not be prorated according to the number of months remaining in the policy year. The full amount will be made available to the member.

The fund amount may also be determined by the use by the employee of a plurality of health related facilities and/or services, in which case, the greater the use by the employee of the plurality of health-related facilities and/or services, the greater the reward will be.

The method may further include calculating a number of points earned by the member in an incentive program operated by the health insurer or third party administrator of the health insurance plan, wherein the number of points are used to determine the size of the fund.

An example of such an incentive program is presently managed by the applicant which manages a traditional indemnity health insurance plan together with their so-called Vitality™ program disclosed in the applicant's co-pending U.S. patent publication Ser. No. 09/982,274, the contents of which are incorporated herein by reference.

The Vitality program rewards members for utilizing approved health related facilities and/or services. For example, members are rewarded for utilizing membership of health clubs, membership of gymnasiums, membership of fitness programs, weight loss programs and programs to quit smoking.

Members are also rewarded for using preventive medical procedures, medical advice services and predetermined procedures, for example, pre-authorization of hospitalization, advance pre-authorization of treatment, registration for electronic funds transfer and compliance with preferred procedures.

Members are rewarded by a points allocation system and depending on the total number of points allocated to a member, they fall within one of four statuses. In the implementation of the Vitality program, these statuses have been named in ascending order of value, blue, bronze, silver and gold. All members are placed initially in the blue status. Once a member has accumulated a predetermined number of points, his/her Vitality status is upgraded to the next appropriate level.

Returning now to the fund in general, an example of benefits available on the fund as a standard offering include:
Health screens
Chronic consultations
Maternity related expenses
Access to eligible benefits without a GP referral

The following benefits will be available to corporate employers as a flexible offering:
Complementary therapy
Infertility investigations
Benefits within the core product where the member has already exceeded their limit (e.g. physiotherapy)
Private GP. Selection of this benefit will typically add an amount to the premium.

Corporate employers will be able to switch benefits from the optional list with benefits on the standard list. This will be cost neutral to the employer.

Detail of services covered per benefit:

| Benefit | Services |
|---|---|
| Health screens | The medical insurance existing |
| | network will be the provider for these |
| | services. |
| | The amount paid will be based on the |
| | current amounts available for |
| | members based on Vitality status |
| | Claims from other service providers |
| | will not be covered. |
| Chronic consultations | Consultations |
| | Related pathology and radiology |
| | A chronic authorisation process will |
| | be developed in order to identify |
| | these claims from other consult |
| | claims. |
| Maternity related | Scans |
| expenses | Consultations (specialists and |
| | midwives) |
| | Pathology |
| | The delivery itself will not be paid |
| | from the fund |
| Access to eligible benefits | Any outpatient benefits currently |
| without GP referral | offered on the product with the same |
| | criteria with the exception of a GP |
| | referral |
| | Eligible benefits will be plan specific, |
| | e.g. complementary medicine is not |
| | an eligible benefit on certain medical |
| | insurance plans |
| Complementary therapy | As per criteria to approve for the |
| | normal benefit |
| Private GP | Consultations |
| | Diagnostic tests |
| | Procedures |
| Infertility investigations | Consultations |
| | Diagnostic tests |
| | Procedures (for diagnosis not |
| | treatment) |
| Limits exceeded | Same criteria will apply as per the |
| | normal benefit when limits are |
| | available. |
| | Applies to outpatient benefits only. |
| | This benefit will apply anywhere |
| | where a member is eligible for |
| | normal benefits however medical |
| | insurer is not paying, e.g. limits |
| | exceed, tariff shortfalls. |
| | It will not apply where medical insurer |
| | is not covering due to an underwriting |
| | exclusion, as this is NOT an eligible |
| | benefit. |
| | This will not apply to excesses |

As the fund is not a medical insurance fund in the normal sense, certain claims procedures which apply to normal claims made to the medical insurer need not apply. For example:
No authorisation for each claim.
No national health gatekeeper will be required to access the services.
Tariffs will not apply, except for health screens.
Claims will only be paid for registered practitioners.
Underwriting exclusions will also apply to the fund. This will not be strictly managed, due to the fact that there is no authorisation.
The only “network” arrangement in place will be for health screens.
No other tariff arrangements will exist. The fund is positioned as the member's money, and it is up to the consumer to see value in the price and the service.
Private GPs can refer members for treatment at other practitioners, such as consultants, as long as it is clinically appropriate and the service is authorised.
No overall limit exists for claims or amount of money in the fund.
In order to identify chronic claims from acute claims, members will register their condition and treating doctor with the medical insurer, in this way they will not need to authorise each chronic claim.
The registration process will assist the service team to service these members appropriately, as well as lay the foundation for future development of a chronic benefit.
Chronic conditions may include:

A disease, illness or injury, and has at least one of the
following characteristics:
It continues indefinitely and has no known cure
It comes back or is likely to come back
It is permanent
It means the patient need to undergo rehabilitation or be
specially trained to cope with it
It needs long-term monitoring, consultations, check-ups,
examinations or tests.

Chronic conditions which are also scheme or underwriting exclusions will not be covered from the fund. This will be determined as part of the registration process, and not the claim process. E.g. If asthma has been excluded as part of the underwriting process, then ongoing chronic claims will not be covered by the fund.
Members will need to inform the medical insurer of any changes, i.e. development of a new chronic condition or a change to their treating doctor.
It will be appreciated that if members have to authorise their chronic condition with the medical insurer it allows the following advantages:
   Only one interaction with the member instead of each time the member claims
   Allows the insurer the opportunity to explain the benefit and why authorisation is required per event for acute flare-ups of chronic conditions
   Allows the insurer the opportunity to inform the member about other programmes if they have the appropriate condition.
Claims will be paid for each policy year based on the total balance available in the fund, and not based on being specific amounts per year. Therefore if a member runs out of funds in Y1, however has funds available in Y2, a claim from Y1 (provided it is within the stale claims period) can be paid with the new money available.
Claims will be paid as they reach the insurer, therefore over a renewal period Y1 claims will not be prioritized from Y1 funds and Y2 claims from Y2 funds.
If there is money available, and the claim is valid it will be paid for (provided it meets the benefit criteria)

The methodology described above could be incorporated into a Vitality rewards scenario where cash back rewards to a member could be paid by way of the fund.

By way of background, the cash back option refers to Vitality rewards where under employees on company paid schemes can get a reward on renewal which depends on their family size, Vitality status, and level of claims. As an example, a couple who get to Platinum status and don't claim can get £700 back in cash if their employer renews the policy.

Depending on the choice made by the employer, this reward could be given in the form of Personal Health Fund rewards—e.g. instead of £700 cash, the employee would get £1,050 of PHF benefit.

In one embodiment a 50% increase can be applied if the PHF rewards are chosen.

The following principles could apply to this scenario:
Employers will choose up front whether the premium reward for their employees is a cash back or a top-up. If an employer does not select an option they will be defaulted to cash back.
A corporate scheme which has selected a zero balance in their health fund should be defaulted to cash-back, however they still have the choice to top-up.
Top-up works based on the same calculation as the cash back. The cash back that the member would receive is allocated to the health fund instead of a cash payout, with an added incentive of 50%.
The top-up option has a 50% booster, therefore if a member is getting a £100 premium reward, £100+50%=£150 will be allocated into the Personal Health Fund for use the following policy year.
The top-up money in the fund will be automatically accessible for the member and the PHR is not a requirement to access the money.
The booster amount must be developed to be flexible, however the default will be 50%.
Three different cash back tables will still exist for corporates, as part of the new business process a cash back table will always be assigned/selected, the if the top-up option is selected by the employer it is based on the cash back amount.
The system is built to accommodate a combination for flexibility.
The profit share will still be calculated in the same way. Claims from the fund will NOT count as claims for the profit share calculation.
Claims from the fund will not count towards the P-C calculation at renewal.

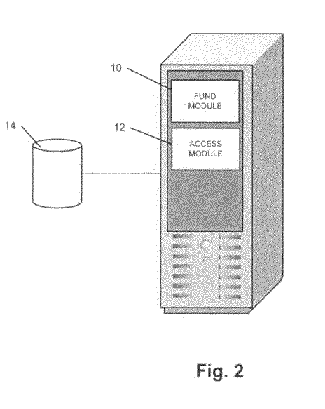

A system to implement the above is illustrated in FIG. 2. The system includes

A fund module 10 to set up a fund for a member which the member can use to pay for predetermined health related expenses.

An access module 12 only allows the member to access the fund if the member participates in a review of their health.

The modules may be implemented by a processor disposed in communication with a memory.

The processor may include modules which are implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

We claim:

1. A method of managing the business of a health insurance plan, wherein the provider of such health insurance plan undertakes liability in return for a premium or contribution, and insures members who pay such premiums or make such contributions for covered health services or manages an account from which covered health care expenses are paid, the method including:
setting up a fund for a member which the member can use to pay for predetermined health related expenses; and
only allowing the member to access the fund if the member participates in a review of their health.

2. A method according to claim 1 wherein the predetermined health related expenses are expenses which are not otherwise covered by the health insurance plan.

3. A method according to claim 2 wherein the health related expenses are one or more of:
eligible benefits without GP referral;
consultations for chronic conditions;
maternity costs; and
health screens.

4. A method according to claim 1 wherein the fund is accessible by a member for a predetermined period.

5. A method according to claim 4 wherein any balance in the fund after the predetermined period is rolled over to the next predetermined period.

6. A method according to claim 5 wherein the balance in the fund is only available if the member participates in the review of their health in this predetermined period.

7. A method according to claim 1 wherein the amount of the fund is related to at what point in the predetermined period the member participated in the review of their health.

8. An electronic system for managing the business of a health insurance plan includes:
a fund module to setting up a fund for a member which the member can use to pay for predetermined health related expenses; and
an access module to only allow the member to access the fund if the member participates in a review of their health.

9. A system according to claim 8 wherein the predetermined health related expenses are expenses which are not otherwise covered by the health insurance plan.

10. A system according to claim 9 wherein the health related expenses are one or more of:
eligible benefits without GP referral;
consultations for chronic conditions;
maternity costs; and
health screens.

11. A system according to claim 8 wherein the access module only allows the member to access the fund for a predetermined period.

12. A system according to claim 11 wherein any balance in the fund after the predetermined period is rolled over by the access module to the next predetermined period.

13. A system according to claim 12 wherein the access module only makes the balance in the fund available if the member participates in the review of their health in this predetermined period.

14. A system according to claim 8 wherein the access module relates the amount of the fund to at what point in the predetermined period the member participated in the review of their health.
